(19) United States
(12) Patent Application Publication
(10) Pub. No.: US 2023/0090410 A1
(43) Pub. Date: Mar. 23, 2023

(54) Artificial Reality Input Models

(71) Applicant: Meta Platforms Technologies, LLC, Menlo Park, CA (US)

(72) Inventors: Priyanka SHARMA, Cupertino, CA (US); Camila Cortes DE ALMEIDA E DE VINCENZO, Seattle, WA (US); Norah Riley SMITH, Oakland, CA (US); Matthew Alan INSLEY, Seattle, WA (US)

(73) Assignee: Meta Platforms Technologies, LLC, Menlo Park, CA (US)

(21) Appl. No.: 17/819,436

(22) Filed: Aug. 12, 2022

Related U.S. Application Data
(60) Provisional application No. 63/332,805, filed on Apr. 20, 2022.
(60) Provisional application No. 63/327,424, filed on Apr. 5, 2022.
(60) Provisional application No. 63/289,362, filed on Dec. 14, 2021.

(51) Int. Cl. G06T 19/00; G06F 3/01

(52) U.S. Cl. CPC G06T 19/006; G06F 3/017; G06F 3/013

(57) ABSTRACT

Aspects of the present technology can identify a current context of a device and select a background image for the device based on the context. Further aspects of the present technology can associate a user's command with an object in her environment. Yet further aspects of the present technology can map a user's range of wrist motion to coordinates of a selected region in an XR environment.

### CROSS REFERENCE TO RELATED APPLICATIONS

This application claims priority to U.S. Provisional Application Numbers 63/289,362 filed Dec. 14, 2021 and titled “Automatic Device Backgrounds from Context,” 63/332,805 filed Apr. 20, 2022 and titled “Associating a Command with a Remote Object,” and 63/327,424 filed Apr. 5, 2022 and titled “Mapping Pointing Gestures to a Selected Region.” Each patent application listed above is incorporated herein by reference in their entireties.

### BACKGROUND

Personal devices have become standard, with users typically carrying between one and four personal devices at any given time. For example, a user may have a phone, smart watch, tablet, smart ring, artificial reality device, and others. While many of these devices are capable of gathering various types of contextual data, they can often still feel fairly generic—e.g., with standard configurations, backgrounds, interfaces, etc. Further, to make these devices feel more customized typically takes significant effort, such as to constantly select appropriate and recent personalizations.

As artificial reality (XR) environments become richer and more complex, the number of real and virtual objects with which a user can interact increases dramatically. This proliferation of choice can be tiring or even overwhelming to the user. Even once the user knows exactly which object she wishes to interact with, selecting just that one object for interaction from a crowded field in an XR environment can be frustratingly cumbersome, sometimes involving the user walking up to the object to touch it, stepping through a series of menus, or choosing a numbered object from a large visual grid.

Artificial reality systems map user body configurations and gestures to actions in the XR world. For example, a user directs a “pinch-point” at a virtual tablet object to select that object for further interaction. These mappings are generally based on visual hand-tracking systems in the user's XR headset. Existing systems map the locations of the user's hands in space, including her fingertips and knuckles, but do not track the three degrees of freedom that each of her wrists provides, e.g., the relative position of the wrist to the user's forearm. Because wrist poses are not directly tracked, users are typically required to use standard rays to interact with UI elements. However, such rays can be difficult to precisely control, especially when interacting with surfaces that are farther away or where small movements can cause different control interpretations. The effects of these inaccuracies are compounded when the user attempts to confine her pointing to a small region in the XR environment, such as the surface of the virtual tablet object.

### SUMMARY

Aspects of the present disclosure are directed to a device background system that can identify a current context of a device and select a background image for the device based on the context. The device can be, e.g., a smartwatch, phone, tablet, etc. Examples of contextual factors that can contribute to a device context include calendar events occurring on or around the current time, a history of events from a set period ago (e.g., one month ago, one year, ago, five years ago, etc.), a current location, nearby people, etc. The device background system can use the identified context to identify matching photos for the device background, e.g., by matching tags or by applying a machine learning model trained to match a context to a photo. In some cases, the device background system can personalize this model based on a user's previous background image selections.

Further aspects of the present disclosure are directed to a system for associating a command with a user-selected real or virtual object in an artificial reality (XR) environment. The user can select a particular object for interaction by directing her gaze or a pointing gesture to the object when she utters a command that she wishes to be associated with that object. In some variations, the contents of the user's command indicate which object to associate with the command. The user can intend that the selected object perform the command (“increase the volume”) or that the XR shell perform the command in relation to the selected object (“bring me that”). In some variations, if the system cannot disambiguate the command's target to only one object, it can produce for the user a visual display of the possibilities, in some variations spreading them out to make the user's subsequent selection easier.

Additional aspects of the present disclosure are directed to mapping a user's wrist-based pointing gestures to a point within a selected region in an artificial reality (XR) environment. At the time the user points to the region to select it for further interaction, the pose of her pointing wrist (i.e., her wrist's pitch and yaw with respect to her forearm) is determined, and her wrist's ranges of angular motion are calculated. These ranges are mapped to ranges of the selected region. For example, the pose of her wrist at maximum upward pitch is mapped to the region's top edge, while the pose of her wrist at maximum left yaw is mapped to the region's left edge. In this manner, the effective “target zone” of her wrist-based pointing gestures is reduced from the entire XR environment to the smaller area of the selected region, thus increasing the precision of her pointing within that region.

### BRIEF DESCRIPTION OF THE DRAWINGS

FIG. 1 is an example system for identifying a current context of a device and selecting a background image for the device based on the context.

FIG. 2 is an example of identifying a location context and setting a device background image based on the location context.

FIG. 3 is a flow diagram illustrating a process used in some implementations for identifying a current context of a device and selecting a background image for the device based on the context.

FIG. 4A is a conceptual diagram of a user directing her gaze to select an object she wishes to interact with.

FIG. 4B is a conceptual diagram of a user pointing her finger to select an object she wishes to interact with.

FIG. 5 is a flow diagram illustrating a process used in some implementations of the present technology for associating a command with a remote object.

FIG. 6A is a conceptual diagram illustrating a user selecting a region in the XR environment by means of a pinch gesture.

FIG. 6B is a conceptual diagram illustrating a user moving a cursor in a selected region by changing a wrist pose.

FIG. 7 is a flow diagram illustrating a process used in some implementations of the present technology for creating a mapping of pointing gestures to a region in an XR environment.

FIG. 8 is a flow diagram illustrating a process used in some implementations of the present technology for mapping pointing gestures to a region in an XR environment.

FIG. 9 is a block diagram illustrating an overview of devices on which some implementations of the present technology can operate.

FIG. 10 is a block diagram illustrating an overview of an environment in which some implementations of the present technology can operate.

### DESCRIPTION

Aspects of the present disclosure are directed to a device background system that can identify a current context of a device and select a background image for the device based on the context. The device can be, e.g., a smartwatch, phone, television, smart home display, artificial reality device, tablet, etc. The device background system can include a context engine that can pull data from various sensors and external data sources to determine a context. The context can include explicit data items identifying various context factors or can include an embedding of such data items generated by a model trained to take context factors and provide a corresponding embedding. Examples of context factors that can contribute to a device context include a calendar of events occurring on or around the current time, a history of events from a set period ago (e.g., one month ago, one year, ago, five years ago, etc.), a current location, nearby people, etc.

Once a context is created, the device background system can use it to identify matching photos for the device background. In some implementations, the device background system can match explicit data elements in the context to photo tags to select a photo (e.g., a photo that has the most matching tags). In other implementations, a machine learning model can be trained to match the context to photos (e.g., using training data of photos users have tagged with context identifiers, such as on social media). In some cases, the device background system can exclude from the matching certain photos, such as those the user has previously manually removed as a background after having been selected by the device background system, photos that were already set as a background recently, or photos identified as having private material. In some cases, the device background system can personalize this model based on a current user's previous background image selections. For example, if the device background system selects a background image that the user then immediately changes, this can be a negative training item and if the user manually selects a background image, it can be paired with current context factors as a positive training item.

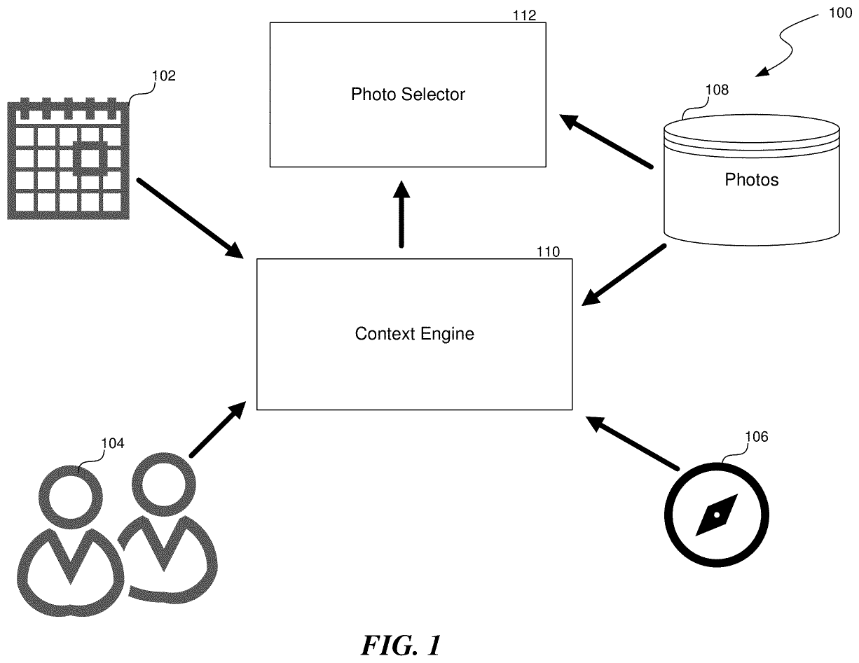

FIG. 1 is an example system 100 for identifying a current context of a device and selecting a background image for the device based on the context. System 100 includes a context engine 110 and a photo selector 112. The context engine 110 receive context factors from a variety of factors including a user's calendar 102, identifications of other users in the vicinity 104, a current location 106, and photo meta data from existing photos 108. The context engine can then combine these values into a context or can use a model trained to embed these values into a context embedding. The context engine 110 can supply this context to the photo selector 112. The photo selector 112 can use this context to match with photos from the photos 108, such as by applying a machine learning model to get match scores between the context and photos or by determining an amount of context factors that match photo meta data/tags. The photo with the best match can be used as a background for a device.

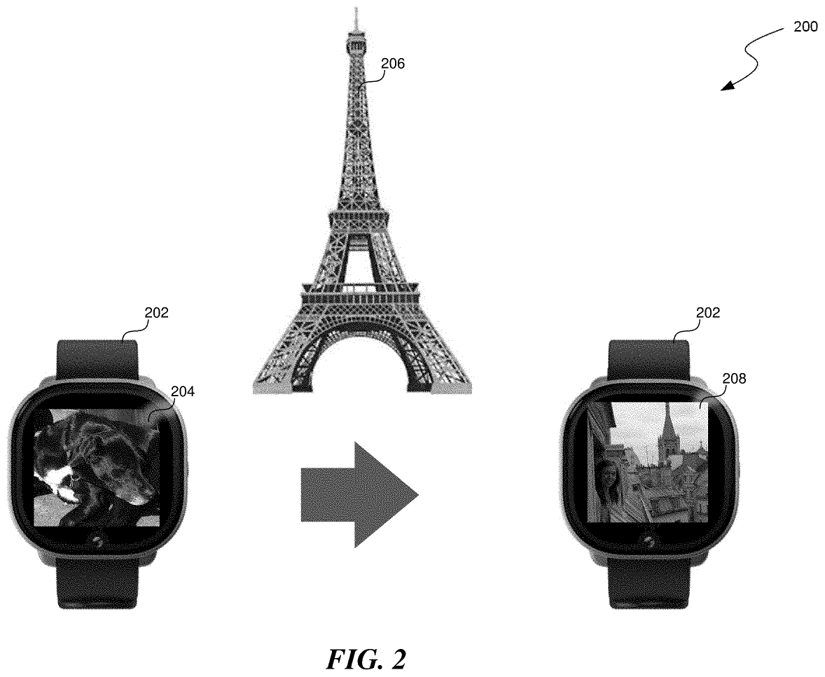

FIG. 2 is an example 200 of identifying a location context and setting a device background image based on the location context. In example 200 a device 202 has a background image 204 initially set. The device 202 has identified a context of a location change, based on a determination that the device is in Paris, France (i.e., location 206). Based on this context, the device 202 has selected, from the user's photos, a photo 208 from the last time the user was in Paris, France and has automatically set this photo 208 as the background photo of the device 202.

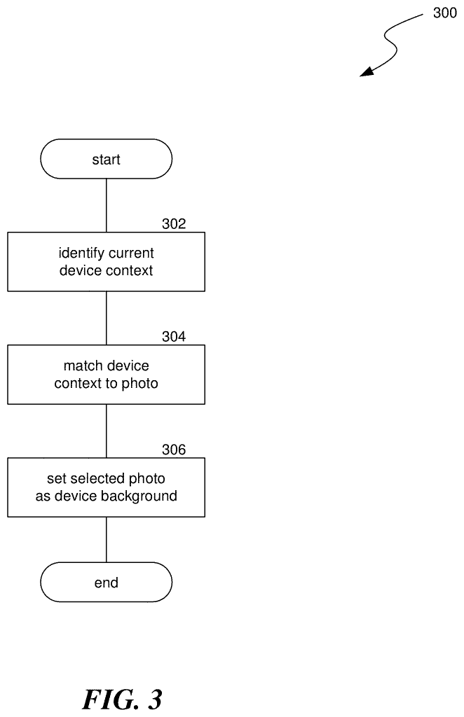

FIG. 3 is a flow diagram illustrating a process 300 used in some implementations for identifying a current context of a device and selecting a background image for the device based on the context. In some implementations, process 300 can be performed on the device or can be performed on a server system with the resulting image being indicated to the device to set as the background. In various implementations, process 300 can be performed at regular intervals (such as every 1, 5, or 15 minutes) or can be performed in response to a determined threshold change in context factors (e.g., when the device is moved a threshold distance or when a new person is detected in the area).

At block 302, process 300 can identify a current context of a device. The device can be, e.g., a smartwatch, phone, television, smart home display, artificial reality device, tablet, etc. In various implementations, identifying the current context can include getting data from sensors and modules associated with the device (e.g., a camera, GPS unit, internal calendar, wireless signals—e.g., to communicate with devices of local users, LIDAR unit, etc.) and/or from external data sources (e.g., a location tracking server—tracking the device's location and/or locations of others' devices, a calendar service, a photo service, etc.)

Examples of the contextual factors gathered from such various sources include events from the current user's calendar (e.g., being at a sporting event or concert, a holiday or birthday, an anniversary, etc.—in some cases, recurring events on the calendar can be those used for the context), a current location of the user (e.g., landmark or area of interest, building, driving route, city, state, country, etc.), what other people are within a threshold distance of the current user (e.g., those with a certain type or distance of connection with the current user on a social graph), or a history of the current user (e.g., what the user was doing, where she was, who she was with, etc. on this date last year, 5 years ago, etc.) In some implementations, the context can be instances of the data entered into corresponding slots in a data structure; while in other implementations the context can be an embedding whereby a machine learning model, trained to encode these data items, takes them and produces an embedding.

At block 304, process 300 can select a photo matching the identified context. In various implementations, the photo can be selected from the user's photos (stored locally on the device or in a cloud service), from social media photos of the user or from another user related to the user on a social graph, from public photos (e.g., nature photos, city photos, landmark photos, etc.), from sources designed by the user as background photos (e.g., from a particular set of the user's albums or from another source designated by the user), etc. In some implementations, process 300 can match explicit data elements in the context to photo tags to select a photo (e.g., a photo that has the most matching tags). In other implementations, a machine learning model can be trained to match the context to photos (e.g., using training data of photos users have tagged with context identifiers, such as on social media). In some cases, process 300 can exclude from the matching certain photos, such as those the user has previously turned off after having been selected, photos that were recently set as a background, or photos identified as having private material. In some cases, process 300 can personalize the matching machine learning model based on a current user's previous background image selections. For example, if a background image was selected that the user then immediately changes, this can be a negative training item and if the user manually selects a background image, process 300 can pair the image with the current context as a positive training item. At block 306, process 300 can set the selected photo as the background image for the device. Process 300 can then end.

A user in an XR environment selects a virtual object with which she wishes to interact by focusing her attention on that object. A command from the user is associated with the object that is the focus of her attention when she utters the command. The command is analyzed. If the command is intended to be performed by the selected virtual object, then the command is sent to it to be performed. If the command is intended to be performed in relation to the selected virtual object, then the command is sent to the XR shell to be performed in relation to the selected virtual object. When the system cannot disambiguate the target of the command, it presents a set of possible target virtual objects to the user so that she can select the one or more she wishes to select.

In some variations, the system determines the focus of the user's attention in one or more ways. In some variations, an eye-tracking and/or head-tracking system monitors the direction of her gaze. The command she utters is associated with the virtual object or objects she is looking at when she utters the command. In some variations, a gesture-tracking system monitors the position of the user's hands. If she is making a pointing gesture when she utters the command, then that command is associated with the virtual object or objects she is pointing at when she utters the command. In some variations, contextual information from the user's environment is combined with an analysis of the command to determine the appropriate virtual object to associate with the command. As an example of using contextual information, the command “bring me the large cat” is analyzed in conjunction with knowledge of the speaker's current XR environment, and if that environment contains at least one cat, then the largest of the cats is taken to be the target of the command. The system then brings her the largest cat.

The analyzed command is then either sent to the selected virtual object to be performed or to the XR shell to be performed in relation to the selected virtual object.

In some situations, the system cannot determine which virtual object the user intends to select. The system can then present to the user for selection the possible target objects it determines may be intended. If the objects are very close together, then they can be presented in a spread out fashion to make the user' subsequent selection easier.

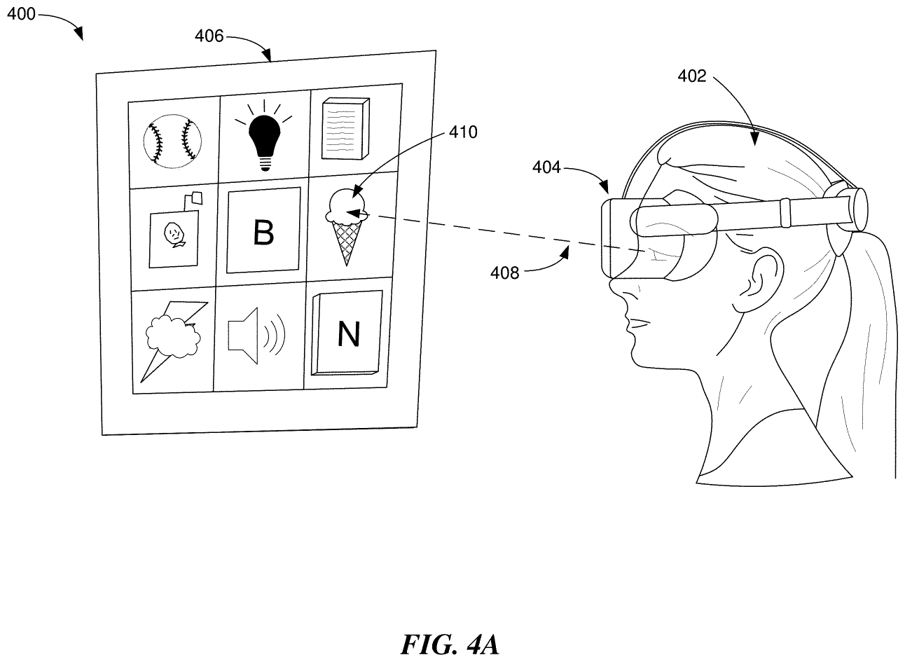

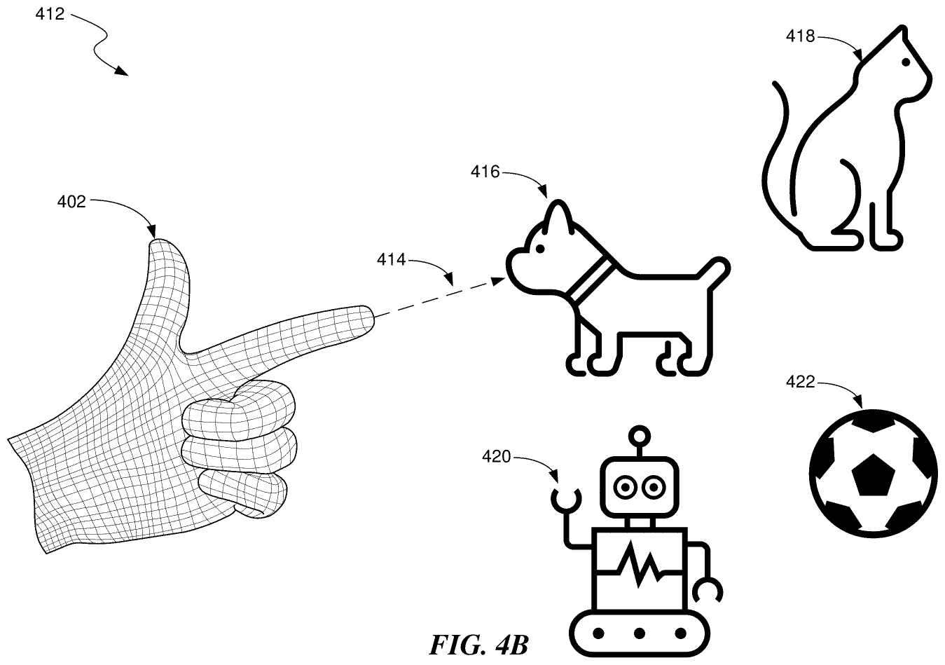

FIG. 4A is an example 400 of a user 402 directing her gaze to select an object 410 she wishes to interact with. She is wearing a head-mounted display (HMD) 404, as described below. Her HMD 404 includes an eye-tracking system that determines the direction of her gaze. In the scenario 400, the display panel 406 in front of her is an interactive menu. At the time when she utters the command “I would like to order one of those,” the eye-tracking system determines that she is gazing at the ice cream cone icon 410 and orders one for her.

Note that if the user 402 is in an augmented or mixed reality environment, then some of the objects in her view may be real. In this case, she can, for example, focus on a real car parked near her and utter the command “tell me the make and model of that car.” The system understands this command and attempts to comply with it.

If due to the smallness of the menu items on the display panel 406 or due to inaccuracies in the eye-tracking system, the system cannot determine which icon the user 402 is gazing at, then the system can enlarge for the user's view the portion of the display panel 406 centered around where it believes the user 402 is gazing. The system then asks her to repeat her selection. Because the menu items have been temporarily enlarged, the system can more readily determine that she wishes to select icon 410.

In some cases, the command and the selected object might not be compatible. The system recognizes this incompatibility and asks the user 402 to clarify her command or her selection.

FIG. 4B is an example 412 of the user 402 pointing at an object to select it. As in the scenario 400 of FIG. 4A, the system determines the user's attentive focus at the time she utters a command, say, “bring me that.” A gesture-tracking system, also in her HMD 404 (not shown in FIG. 4B) determines that she is making a pointing gesture, and that the direction of her gesture is as shown by the arrow 414. The system analyzes the pointing direction 414 in conjunction with the user's current environment. It concludes that the robot 420 and the ball 422 are not the intended objects of the gesture. However, the gesture points to both the dog 416 and the cat 418. In some cases, the system selects the pointed-to object that is closer to the user 402, here the dog 416. In other cases, the system presents the possibilities of the dog 416 and the cat 418 to the user and asks her to choose which one she wants (e.g., by adding “1” and “2” labels to the candidate objects and asking the user to pick a number). Once she makes the choice, the command is executed.

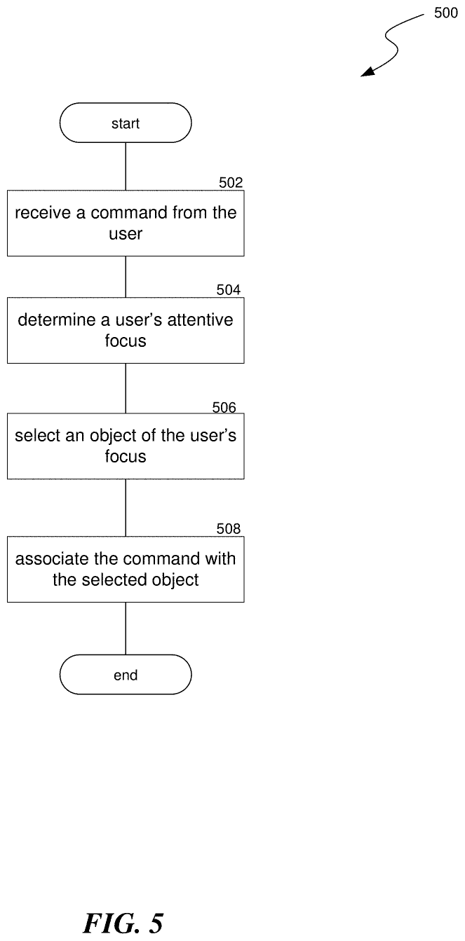

FIG. 5 is a flow diagram illustrating a process 500 used in some implementations for associating a user's command with a remote object in an XR environment. In some implementations, process 500 is constantly running listening for commands as long as the user 402 is in the XR environment, as indicated by, for example, powering on the HMD 404. Process 500 may also be invoked whenever the user 402 makes an utterance that is interpreted as a command. For example, a program in the user's XR environment, called the XR shell, receives and decodes (e.g., by applying a natural-language processor) an utterance from the user 402. The XR shell determines that the utterance contains a command and invokes process 500 to process the command. In some variations, process 500 is run entirely or in part on the user's local XR system. In some variations, process 500 can access services running on remote servers, such as natural-language processors to decode commands.

In some situations, the user 402 can utter a command whose intended object is entirely explained by the contents of the command itself. For example, “bring me that cat” is self-explanatory when there is only one cat in the user's current XR environment. In some variations, these self-explanatory commands are not sent to process 500.

If, however, the intended object of the command is not already known, process 500 can be invoked. At block 502, process 500 can receive the command from the user 402. In some variations, the command has already (that is, before block 502 begins) been decoded from a verbal utterance to a structured string of words, and process 500 receives that structured word string. In some variations, process 500 uses that word string in the following blocks to help it to direct the command to the intended object.

At block 504, process 500 attempts to determine the focus of the user's attention at the time she uttered the command. Looking ahead, from the determined attentive focus, process 500 at block 506 attempts to determine which object in the user's XR environment is the intended target of her command. In some variations, process 500 can apply one or more “target-association modalities” to the task. In a first modality, the target object is determined by decoding the direction of the user's gaze at the time she utters the command. An eye-tracking system linked to cameras in her HMD 404 monitors her gaze direction. As in the scenario 400 of FIG. 4A, that gaze direction is then extrapolated into her current XR environment. Process 500 uses this extrapolation to determine what object or objects are in the user's line of sight. Those objects are candidates for the target object of the command.

Instead of selecting the intended target object of her command by looking at it, the user 402 can point at the object as in the scenario 412 of FIG. 4B. In this case, process 500 can apply a second target-association modality. A gesture-tracking system, also based on cameras in the user's HMD 404, decodes the direction in which she is pointing. As with gaze-tracking, the pointing direction is extrapolated into the user's current XR environment, and the process 500 uses the extrapolation to determine as candidates the objects that are in the pointed direction.

Applying a third target-association modality, process 500, as mentioned above, can use the words of the user's command to help it determine the intended target of the command. Repeating an example from above in a slightly different user context, the command “bring me that cat” is, when there are multiple cats in the user's current environment, ambiguous without more information, but it does at least exclude all non-cat objects from consideration as candidate targets of the command.

At block 506, process 500 takes the list of intended target object candidates produced by block 504. Any of the above target-association modalities (i.e., gaze-tracking, pointing-gesture tracking, and word decoding) may result in only one candidate target for the command. In that situation, process 500 takes that one candidate and proceeds to block 508.

However, in some situations, each of the target-association modalities could result in multiple candidates. For example, in FIG. 4B, the user's pointing direction 414 intercepts both the dog 416 and the cat 418. Note that a further source of ambiguity can arise when process 500 notes multiple target-association modalities simultaneously in play. For example, the user 402 can be gazing decidedly in one direction, pointing in another, and uttering a command that is not clearly compatible with objects along either direction.

When the user's intended selection is ambiguous, process 500 can use one or more techniques to resolve the ambiguity. As a first technique, in some variations, process 500 makes an intelligent choice. In the example of FIG. 4B, the dog 416 is closer to the user, so process 500 can assume that the dog 416 is intended to be selected over the cat 418. In another example, objects invisible to the user are unlikely to be selected by the user's pointing gestures.

As a second technique for resolving ambiguity in some variations, process 500 can ask the user 402 which of the multiple candidates is the intended target of her command. To make this second selection easier and less ambiguous, the candidate targets can be presented to the user 402 in a way that highlights them while de-highlighting any other, non-candidate, objects in her current XR environment. The candidate targets can be brightened or made more distinct against their background. In some variations, process 500 can temporarily move the candidate targets together and present them for the user's selection in one magnified view. By magnifying the candidate targets, process 500 makes the user's subsequent choice easier to interpret. Process 500 can also add temporary tags (e.g., numbers, letters, words, etc.) to the candidate targets and let the user 402 unambiguously select a target by specifying its tag. Process 500 can also use this second technique of asking for clarification from the user 402 in situations where process 500 can find no candidate target objects compatible with the user's command.

In a third way to resolve ambiguities when there is input from conflicting target-association modalities, process 500 can invoke a hierarchy of modalities. That is, a pointing gesture can be set to general trump a gaze direction, but that can be overruled when the only objects clearly compatible with the words of the command are being gazed at but not pointed at.

When process 500 has only one candidate object as the intended target of the user's command, it proceeds at block 508 to associate the command with that target object. Here, the user's intended “target” may be an object in her XR environment that should actively perform her command. If, for example, the command is “increase volume” and the intended target is an audio player, then the audio player object is an active target and should perform the command. In other situations, the intended target is meant to be the passive recipient upon which the command is performed. For example, in the command “bring me that cat,” the intended “cat” is not an active target. Instead, the action of the command is performed by the XR shell, and the cat is the passive recipient of the “bring” command.

If the user's decoded command specifies an active target object, then process 500 in block 508 sends the command to that target object for the object to perform.

If the user's decoded command specifies a passive target object, then process 500 sends the command, along with an identification of its passive target object, to the XR shell to perform.

It is anticipated that the above system does not always perfectly interpret the user's intention. While not shown in FIG. 5, process 500 should be able to remember the command and the associated target object for a little while at least so that process 500 can respond to a user's “undo” command.

A user selects a region with an initial gesture and a gesture-mapping system can then map further wrist rotations to points within the selected region. At the time the user points to the region to select it, the gesture-mapping system can determine the pose of her pointing wrist (i.e., her wrist's pitch and yaw with respect to her forearm). Taking that determined wrist pose as input, the gesture-mapping system can calculate her wrist's ranges of angular motion. The gesture-mapping system can then map these angular ranges to linear ranges of position within the selected region. As the user moves her wrist, the gesture-mapping system can use the map to translate the changes in her wrist pose to positions within the selected region, e.g., to controls a position of a pointer within the selected region in accordance with the wrist-pose-to-position mapping.

For example, the selected region can be a two-dimensional display panel presented by a virtual tablet object. The gesture-mapping system can determine the user' wrist pose at the time she selects the display panel for further interaction. After calculating the user's ranges of wrist motion and making a map, the gesture-mapping system can move the virtual tablet's cursor to the top edge of the display panel when the user's wrist is at its maximum upward pitch and move the cursor to the left edge of the display panel when the user's wrist is at its maximum left yaw. This mapping can remain in effect as long as the user continues to interact with the display panel.

The initial pose of the user's wrist can be determined in a number of ways. If the user is wearing a device such as a glove, sleeve, bracelet, or other position tracking device, an artificial reality (XR) system can use output from that wearable to accurately determine her wrist pose. Without such a device, the XR system can use cameras, such as in a user's head-mounted display (HMD), to track her wrist pose, and/or track her hand position and from that infer her wrist pose.

In various implementations, different methods can initially locate the position pointer within the selected region (e.g., to locate the cursor within the display panel of the virtual tablet object). In some cases, the pointer can always start at a particular spot such as in the middle of the selected region or in a corner, while on other cases the pointer can start at a point corresponding to where the user selected the region.

The initial placement of the position pointer within the selected region can, in some variations, inform the gesture-mapping system. If, for example, the initial placement is at the top left corner of the selected region, then the gesture-mapping system can ignore mapping of the user's wrist with a further upward pitch or a further leftward yaw. The gesture-mapping system can then, for example, map the angular range of the wrist's available downward pitch poses (from the wrist's initial pitch at the time of object selection) to the entire vertical range of the region, and similarly with the wrist's available rightward yaw poses.

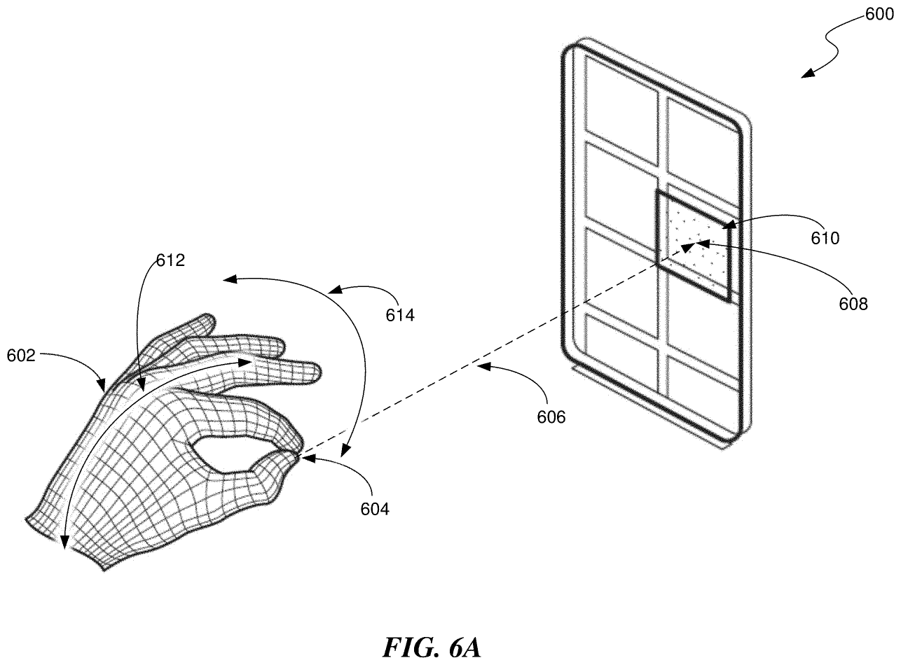

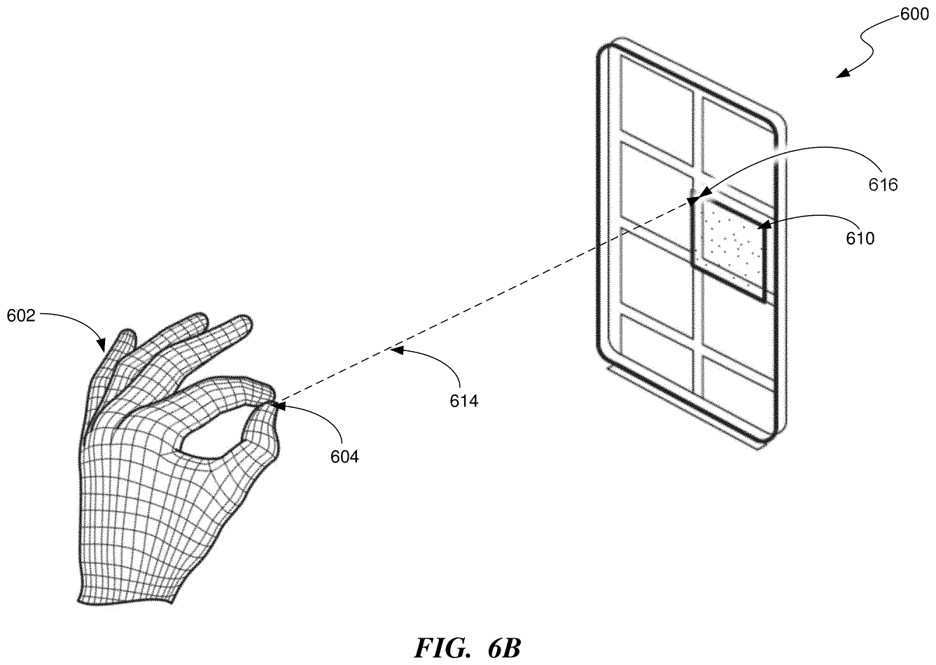

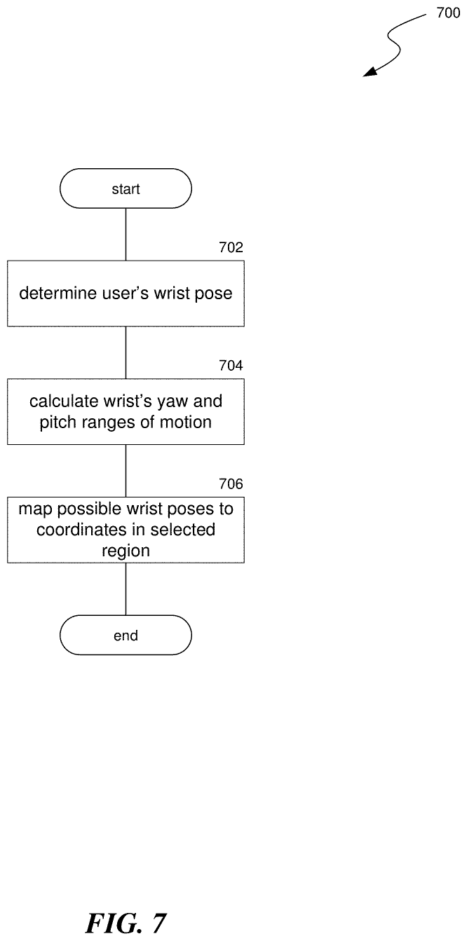

FIG. 6A is an example of a user selecting a region of a virtual object in an XR environment. In the scenario 600 of FIG. 6A, the user 602 makes a “pinch-pointing” gesture. The XR system projects an imaginary “projection cast” ray 606 from her pinch point 604 to a specific point 608 on the display panel 610. (How the XR system determines the projection cast is discussed below in relation to FIG. 7.)

The user's wrist pose at the time she selects the display panel 610 of the virtual object is mapped to the location 608 of the cursor on the display panel 610. From that wrist pose, the user 602 can change the pitch 612 or yaw 614 of her wrist. From the initial wrist pose, the gesture-mapping system determines the limits of these wrist motions. The gesture-mapping system maps the extremes of the user's wrist pitch 612 motions to the vertical dimension of the display panel 610 and maps the extremes of the user' wrist yaw motions to the horizontal dimension of the display panel 610.

The user 602 in FIG. 6B retains her pinch-pointing gesture but has moved her wrist to its maximum upward pitch pose and its maximum leftward yaw pose as shown by her revised projection cast 614. The gesture-mapping system notes her wrist pose in FIG. 6B and applies its previously made map. From the map, the gesture-mapping system associates these extremes of wrist angular pose with the extreme edges of the display panel 610. The gesture-mapping system tells the object presenting the display panel 610 to move the cursor to its upper-left position 616 in accordance with the mapping.

As long as the user 602 continues to interact with the display panel 610 (e.g., as long as she holds the pinch gesture) as in the scenario 600 of FIGS. 6A and 6B, the gesture-mapping system can map her wrist motions to positions on the display panel 610.

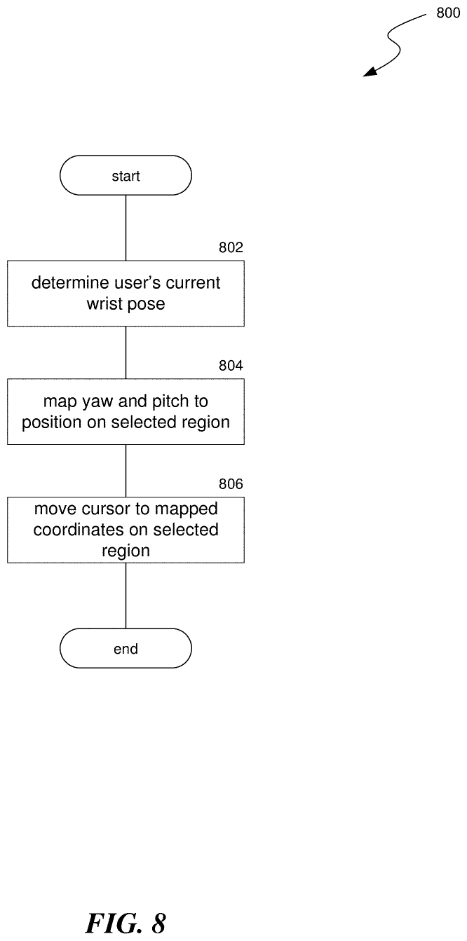

FIG. 7 is a flow diagram illustrating a process 700 used in some implementations for producing a mapping of wrist poses of a user's pointing gestures to coordinates of a region in an XR environment. Process 700 begins when the user makes a pointing gesture to select a region in the XR environment. Once process 700 completes its mapping, the mapping can be used by a process such as process 800 of FIG. 8. When the user selects another region in the XR environment, process 700 can run again. In some variations, process 700 is run by the user's XR system in a shell controlling her XR environment.

As background, a projection cast is a vector determined by a user's pointing gesture that is used to interact with in the XR environment. The projection cast is based, in part, on outputs from a gesture-tracking system, but the gesture-tracking system may introduce inaccuracies due to imprecision in tracking positions and orientations and because of small motions at the user's hands and finger tips, relatively far removed from the user's body. To reduce the effects of these inaccuracies, in some cases, the XR system can determine the projection cast as passing outward from a relatively stable “origin point” on the user's body through a “control point” on the user's hand or fingers. The origin point can be based on outputs from a body-position tracking system. In some variations, the origin point can be a tracked part of the user's body, such as a dominant eye, a hip, or a shoulder associated with a gesturing hand, a point between the hip and shoulder, etc., and the control point can be a part of the user's gesturing hand such as fingertips, a palm, a base of the wrist, or a fist. The origin point can be based on the user's current context such as what gesture the user is currently making or where the user is directing her gaze. For example, the XR system can determine an angle of the user's gaze above or below a plane level with the floor and can select the origin point as a corresponding amount above a midpoint between the user's shoulder and hip if the gaze is below the plane and can select the origin point as a corresponding amount below the midpoint between the user's shoulder and hip if the gaze is above the plane.

To provide inputs to the XR system, the gesture-tracking system tracks the position and orientation of the user's gesturing hand and fingers. In some variations, cameras in the user's HMD or other XR system perform this tracking. In some variations, the gesture-tracking system precisely tracks the position and orientation in space of the user's hands, fingertips, and knuckles. In some variations, the gesture-tracking system determines the pose of the user's wrist from outputs of a tracking device worn at the user's wrist. In some variations without such a wearable device, the gesture-tracking system determines the user's wrist pose by calculating the contribution of the user's wrist pose to the user's current projection cast. This “wrist-contribution vector” is calculated as a vector difference between a projection cast with “high-wrist contribution” (e.g., the pose of the wrist with respect to the arm) and another projection cast with a “low-wrist contribution” (e.g., a body-and-arm component).

At block 702, process 700 can determine the user's wrist pose at the time when she makes the pointing gesture to select the region 610 in her XR environment. This pose is called the “initial wrist pose” in the following discussion. In line with the above background material, process 700 receives input from the XR system's gesture-tracking system about her wrist pose. In some variations, the wrist pose includes the angular pose of her wrist from its neutral pose. With the hand extending straight from the forearm with the palm down, “pitch” is the wrist's motion that causes the hand to angle up and down, “yaw” is the wrist's motion left and right, and “roll” is the turning of the hand caused by rotation of the forearm. The described wrist pose can include pitch and yaw angles and, in some variations, a roll angle.

At block 704, process 700 can determine the yaw and pitch ranges of motion available to user's wrist from its initial pose. These ranges can in some variations be based on general considerations of how an average human wrist can move. Because people differ somewhat in this regard, these ranges can, in some variations, be determined for this particular user 602, e.g., by having her move her wrist from one extreme pose to another while the gesture-tracking system watches and records or by monitoring how far the user has moved her wrist in the various directions in the past. Because these ranges can be set relative to the initial wrist pose, if, for example, the wrist in its initial pose is at an extreme limit of motion in one or more directions, then the ranges only extend in the other direction, to the opposite extremes.

At block 706, process 700 can produce a mapping that ties particular wrist poses (yaw and pitch) to coordinates in the region. One part of this map is the initial position pointer within the selected region, shown as 608 in FIG. 6A, and mapped to the user's initial wrist pose. While some virtual objects can set this initial position pointer based on the user's projection cast 606 at the time when she selects the virtual object, other virtual objects can choose to, for example, always place the initial position pointer in the middle of the region or at the top left corner.

In addition to the initial position pointer, the mapping can associate possible wrist poses with positions throughout the selected region 610. That is, the full pitch of the wrist upward can be mapped to the top edge of the region 610, full pitch downward maps to the bottom edge of the region 610, full yaw left maps to the left edge, and full yaw right maps to the right edge. Intermediate wrist poses are mapped to intermediate positions in the region 610, with a linear relationship established between possible wrist angles and positions in the region 610.

FIG. 8 is a flow diagram illustrating a process 800 used in some implementations for mapping a user's pointing gesture to coordinates of a region in an XR environment. Process 800 runs when the user makes a pointing gesture to an already selected region in the XR environment. In some variations, process 800 uses a mapping created by a process such as 700 of FIG. 7. In some variations, process 800 is run by the user's XR system in a shell controlling her XR environment.

At block 802, process 800 can determine the user's current wrist pose. In some variations, process 800 determines this by applying the same technology and methods discussed above in relation to block 702 of FIG. 7. The determined wrist pose can include yaw and pitch information. In some implementations, the user's wrist pose can be adjusted according to movements of other parts of the user, such as her arm or torso—which can affect the overall position of the user's wrist. For example, a user may move her wrist by a small amount but then further move her arm causing her whole wrist to move by a further amount, and the totality of these movements can be used (in block 804 below) to map the wrist pose to the input location in the selected region.

In some implementations, the additional movements other than wrist pose are only used when the user's wrist is already at a maximum range of motion. For example, the user may have selected a region when her wrist was already bent up as far as it goes, but the default position of the cursor may be the center of the selected region. Processes 700 and 800 can determine that the user's wrist is fully bent and therefore map wrist repositions due to arm or torso movements to cursor movements in the selected region.

At block 804, process 800 uses a predetermined map (e.g., such as can be produced by process 700) to translate the determined yaw and pitch into a position on the selected region 610. As discussed above in relation to block 706, the mapping can be relative to the initial pointing position in the region 610 set by the virtual object that presents the region 610.

At block 806, process 800 can tell the virtual object that presents the display 610 to move its position pointer (e.g., a cursor on a virtual tablet display) to the position within region 610 determined by the mapping results at block 804.

Process 800 can repeat as the user 602 changes her wrist pose while still making a pointing gesture within the selected region 610.

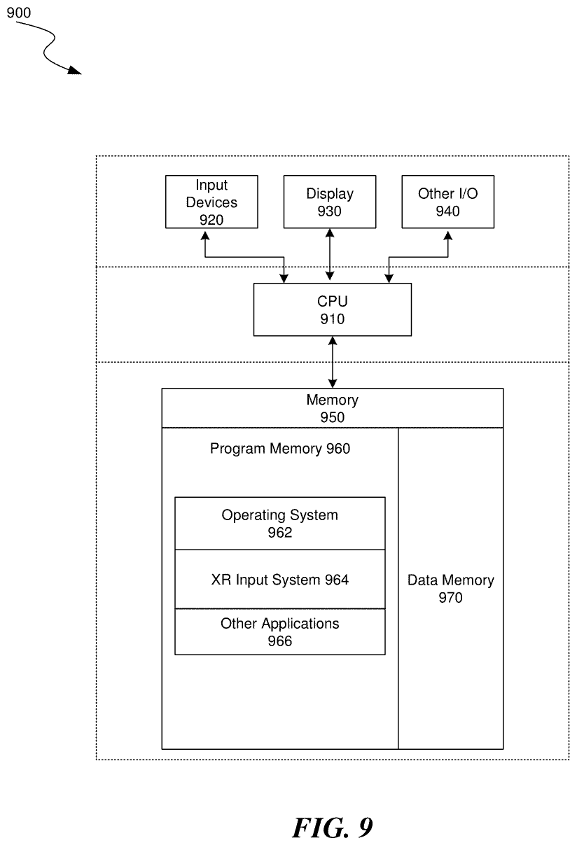

FIG. 9 is a block diagram illustrating an overview of devices on which some implementations of the disclosed technology can operate. The devices can comprise hardware components of a device 900, as show and described herein. Device 900 can include one or more input devices 920 that provide input to the Processor(s) 910 (e.g., CPU(s), GPU(s), HPU(s), etc.), notifying it of actions. The actions can be mediated by a hardware controller that interprets the signals received from the input device and communicates the information to the processors 910 using a communication protocol. Input devices 920 include, for example, a mouse, a keyboard, a touchscreen, an infrared sensor, a touchpad, a wearable input device, a camera- or image-based input device, a microphone, or other user input devices.

Processors 910 can be a single processing unit or multiple processing units in a device or distributed across multiple devices. Processors 910 can be coupled to other hardware devices, for example, with the use of a bus, such as a PCI bus or SCSI bus. The processors 910 can communicate with a hardware controller for devices, such as for a display 930. Display 930 can be used to display text and graphics. In some implementations, display 930 provides graphical and textual visual feedback to a user. In some implementations, display 930 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 940 can also be coupled to the processor, such as a network card, video card, audio card, USB, firewire or other external device, camera, printer, speakers, CD-ROM drive, DVD drive, disk drive, or Blu-Ray device. In some implementations, the device 900 also includes a communication device capable of communicating wirelessly or wire-based with a network node. The communication device can communicate with another device or a server through a network using, for example, TCP/IP protocols. Device 900 can utilize the communication device to distribute operations across multiple network devices.

The processors 910 can have access to a memory 950 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 950 can include program memory 960 that stores programs and software, such as an operating system 962, XR input system 964, and other application programs 966. Memory 950 can also include data memory 970, which can be provided to the program memory 960 or any element of the device 900.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

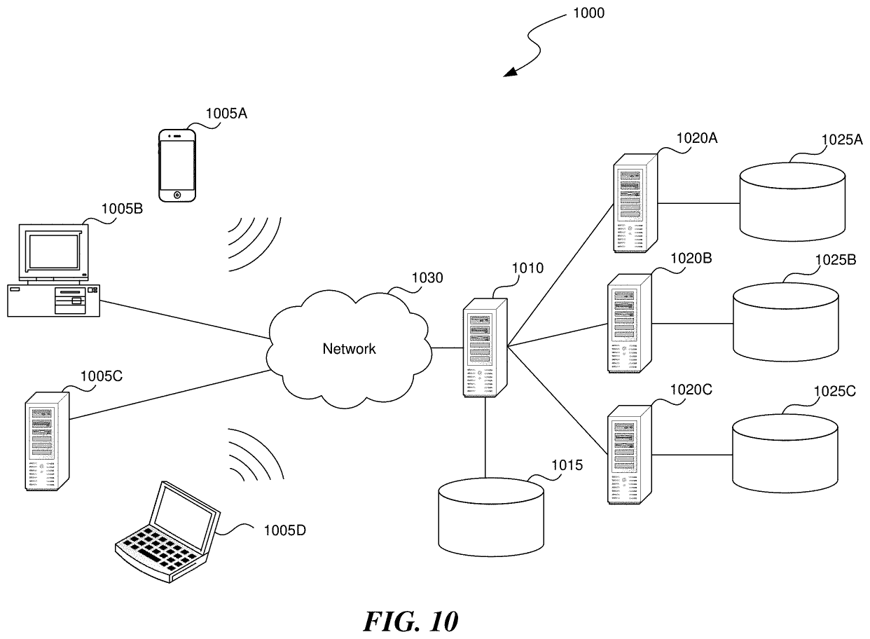

FIG. 10 is a block diagram illustrating an overview of an environment 1000 in which some implementations of the disclosed technology can operate. Environment 1000 can include one or more client computing devices 1005A-D, examples of which can include device 900. Client computing devices 1005 can operate in a networked environment using logical connections through network 1030 to one or more remote computers, such as a server computing device.

In some implementations, server 1010 can be an edge server which receives client requests and coordinates fulfillment of those requests through other servers, such as servers 1020A-C. Server computing devices 1010 and 1020 can comprise computing systems, such as device 900. Though each server computing device 1010 and 1020 is displayed logically as a single server, server computing devices can each be a distributed computing environment encompassing multiple computing devices located at the same or at geographically disparate physical locations. In some implementations, each server 1020 corresponds to a group of servers.

Client computing devices 1005 and server computing devices 1010 and 1020 can each act as a server or client to other server/client devices. Server 1010 can connect to a database 1015. Servers 1020A-C can each connect to a corresponding database 1025A-C. As discussed above, each server 1020 can correspond to a group of servers, and each of these servers can share a database or can have their own database. Databases 1015 and 1025 can warehouse (e.g., store) information. Though databases 1015 and 1025 are displayed logically as single units, databases 1015 and 1025 can each be a distributed computing environment encompassing multiple computing devices, can be located within their corresponding server, or can be located at the same or at geographically disparate physical locations.

Network 1030 can be a local area network (LAN) or a wide area network (WAN), but can also be other wired or wireless networks. Network 1030 may be the Internet or some other public or private network. Client computing devices 1005 can be connected to network 1030 through a network interface, such as by wired or wireless communication. While the connections between server 1010 and servers 1020 are shown as separate connections, these connections can be any kind of local, wide area, wired, or wireless network, including network 1030 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

We claim:

1. A method for identifying a current context of a device and selecting a background image for the device based on the context, the method comprising:
identifying the current context of the device;
matching the current context of the device to a photo; and
setting the photo as a background image for the device.

2. A method for associating a command with a remote object in an XR environment, the method comprising:
receiving a command from the user;
determining a user's attentive focus, the determining based on one or more of: a focus of a gaze of the user, a focus of a gesture of the user, a focus of a verbal utterance of the user, contextual information, the received command, or any combination thereof;
selecting an object corresponding to the user's determined attentive focus; and
performing the command in association with the selected object.

3. A method for mapping pointing gestures to a selected region in an XR environment, the method comprising:
determining a pose of a wrist connected to a hand making a pointing gesture;
from the determined wrist pose, calculating yaw and pitch ranges of motion available to the wrist; and
from the calculated yaw and pitch ranges of motion, producing a mapping of possible wrist poses to coordinates in the selected region.
